(19) United States
(12) Patent Application Publication
(10) Pub. No.: US 2022/0012233 A1
(43) Pub. Date: Jan. 13, 2022

(54) Creation of a Blockchain with Blocks Comprising an Adjustable Number of Transaction Blocks and Multiple Intermediate Blocks

(71) Applicant: Siemens Aktiengesellschaft, Muenchen (DE)

(72) Inventor: Oliver THURAU, Limburgerhof (DE)

(21) Appl. No.: 17/413,035

(22) PCT Filed: Nov. 13, 2019
(86) PCT No.: PCT/EP2019/081111

§ 371 Date: Jun. 11, 2021

(30) Foreign Application Priority Data
Dec. 14, 2018 (EP) 18212701

(51) Int. Cl. G06F 16/23; G06F 16/27

(52) U.S. Cl. CPC G06F 16/2379; G06F 16/27

(57) ABSTRACT

A computer-implemented method for creating a blockchain with blocks that includes an adjustable number of transaction blocks and multiple intermediate blocks, and to a storage medium of a device participating in a distributed database system comprising such a blockchain, wherein a first intermediate block is provided and at least one second intermediate block is generated, where the second intermediate block references a block preceding the second intermediate block and at least the first intermediate block.

### CROSS-REFERENCE TO RELATED APPLICATIONS

This is a U.S. national stage of application No. PCT/EP2019/081111 filed 13 Nov. 2019. Priority is claimed on European Application No. 18212701.9 filed 14 Dec. 2018, the content of which is incorporated herein by reference in its entirety.

### BACKGROUND OF THE INVENTION

### 1. Field of the Invention

The invention relates to a computer-implemented method for creating a blockchain with blocks comprising an adaptable number of transaction blocks and a plurality of intermediate blocks, and to a storage medium of a device participating in a distributed database system having such a blockchain.

### 2. Description of the Related Art

In the industrial sphere there is increasingly an interest in recording data relating to the device itself or an automation system in which the device is situated, or data of a process that is undergone in an automation system of the device, in a protected manner on the device. In particular, quality data from automation control or operating actions performed or a history of detected state data are of interest here. A blockchain and having recourse to a blockchain network are suitable for recording such data on a device in a manner protected against manipulation.

In the industrial sphere, use is made here of a “public” or “private” blockchain, for example. In the case of a public blockchain, the consensus method is public, i.e., an unknown user group, for example, on the public internet, can confirm or validate a blockchain, or more precisely validate individual blocks by “mining”. In the case of the private blockchain, the consensus method occurs within a consortium whose members, for example, are known to one another or to a management entity or satisfy a specific trust level.

Blockchain technology realizes a distributed, decentralized database in which transactions generated by participating nodes can be stored in a manner protected against manipulation. For this purpose, transactions are recorded in a block and a block is linked with a succeeding block via a checksum method. An explanation of blockchain technology can be gathered, for example, from the English-language website called Wikipedia. In a block, a hash value of the predecessor block is recorded, for example, besides one or more transactions. The block is sent to the blockchain network by the node that generated it. Protection arises as a result of a majority of trustworthy nodes in a blockchain network which perform validation of blocks. In the network of the nodes participating in a blockchain, a new block is formed at regular periods and the hash value of an existing block is concomitantly recorded in the process. If no transaction is present in an interval, then the creation of the block is dispensed with in some blockchains.

A blockchain thus stores the transactions that were introduced into the blockchain or were provided to the blockchain network for confirmation. If the blocks are confirmed in the respective consensus method, then the valid blockchain grows with respect to its length and thus size with every confirmed block. The storage space requirement of a continued or confirmed blockchain thus increases ever further.

A checksum, particularly a hash value of the predecessor block, is inserted into a respective new block. As a result, a chain is formed. The checksum of the predecessor block, together with the transaction of the current block, in turn, forms the data set for the checksum of the succeeding block. A block is also said to reference the preceding block. The transactions are thus protected against manipulations because a chain can be traced to an initial block, also called genesis block, through the linking of the blocks. The transactions are available via the blockchain network. As a result, it is possible to trace from which block in the chain, for example, a content of a transaction no longer corresponds to previous versions. Transactions are thus recorded in a manner protected against manipulation in every verified blockchain. Modification of a transaction in a block that had already been formed at an earlier point in time in the network would be able to be traced upon recalculation or checking of checksum formation by way of the existing blocks. On account of the constantly increasing number of blocks within a blockchain, when blockchain technology is used in devices with limited resources there is the risk that not enough storage space will be available in the long run. By way of example, the storage space resources are limited in the case of automation devices, Human-Machine Interface (HMI) devices or edge devices or Internet of things (IoT) devices in contrast to cloud-based systems.

### SUMMARY OF THE INVENTION

Against this background, it is an object of the present invention to provide use of a blockchain such that the storage space requirement for a blockchain at a node can be reduced.

This and other objects and advantages are achieved in accordance with the invention by a computer-implemented method for creating a blockchain with blocks comprising an adaptable number of transaction blocks and a plurality of intermediate blocks, where the blockchain forms part of a distributed database system, blocks are generated within the blockchain and a respective block references a respective preceding block, a first intermediate block is provided; at least one second intermediate block is generated, and where the second intermediate block references a block preceding it and also references at least the first intermediate block.

The blockchain forms part of a distributed database system. Here, distributed database system means that the information of the database, in particular the chain in the form of a blockchain, is available or can be stored at a plurality of locations or for a plurality of participants. The principle of a blockchain in a distributed database system is based on the information from the blockchain being present in a decentralized manner. Participants in the distributed database system can participate in the creation of new blockchains or check or verify blockchains. Furthermore, a participant can also merely access one or more blockchains or use one or more individual blocks of a blockchain.

In accordance with the invention, transaction blocks and intermediate blocks are provided as blocks. A transaction block that references a preceding transaction block is known from the prior art. In particular, a blockchain is constructed by creating a transaction block with transfer of a transaction into the distributed database system and linking with existing transaction blocks. In this way, an existing blockchain chain is as it were continued or extended.

The point at which or the last transaction or the last block on the basis of which the chain is continued is defined by choosing a referenced block in a blockchain chain. In particular, the choice of the block that is referenced during the creation of a blockchain is possible in any desired way. The most up to date block confirmed by the distributed database system is advantageously chosen for the referencing. Chains that are validated or confirmed in terms of their validity are efficiently extended in this way.

It is now proposed to generate at least one intermediate block. Besides the regular referencing of the predecessor block, an intermediate block has a second referencing, specifically a referencing to a predecessor intermediate block. The term referencing should be understood to mean, for example, linking with another block or incorporating another block via checksum formation by way of the incorporated or linked block. This double referencing makes it possible for the blockchain thus generated and confirmed by the decentralized blockchain network to be validated in a flexible manner: firstly, complete tracing of the generated blocks, in particular of all generated blocks, can be performed. Likewise, the chain can be traced based on the intermediate blocks and the references thereof to previous intermediate blocks. Blocks lying between two intermediate blocks, in particular transaction blocks, can be omitted in the validation if the intactness of the chain is traced by way of the intermediate blocks.

A second intermediate block is generated, for example, in a chain of transaction blocks. The second intermediate block is created such that it references a preceding block as it were regularly. That is, the second intermediate block is generated as a block within the blockchain by virtue of its extending or continuing an existing blockchain chain.

In addition, the second intermediate block references at least the first intermediate block. The second intermediate block thus comprises at least two references. These are, for example, the checksums of two different statuses of the blockchain. Firstly, the blockchain is continued in a customary manner by the linking of the preceding block. The preceding block is, in particular, a regular transaction block.

By way of the direct preceding block, the second intermediate block comprises a checksum of the blockchain chain as far as the second intermediate block itself. Moreover, the second intermediate block also comprises a checksum of the blockchain with respect to the status of a generated first intermediate block. By way of example, this is the state of the blockchain after creation or after validation of the first intermediate block.

A reference to an earlier state of the blockchain is thus created via the second intermediate block referencing the first intermediate block.

The blockchain can advantageously be continued based on the second intermediate block. An intactness of transactions recorded in the blockchain is possible via the second intermediate block and the first intermediate block, even if transaction blocks generated between the first intermediate block and the second intermediate block are themselves no longer available.

Advantageously, in accordance with the disclosed method, a current transaction that is made available to the blockchain network and that is intended to be interlinked becomes available for all nodes with the availability of the transaction block in the blockchain network. The method for creating a blockchain with an adaptable number of transaction blocks therefore in particular does not concern the availability of the current transaction blocks.

An intermediate block can be confirmed by the blockchain network analogously to conventional methods for generating a transaction block, such as mining. By way of example, an intermediate block is generated via a mechanism based on proof-of-work or proof-of-stake or proof-of-authority.

In particular, the references of intermediate blocks back to previous intermediate blocks during the generation of further blocks after an intermediate block do not have to be taken into account in a special way. In particular, the validation and interlinking of an intermediate block are also effected in a regular manner.

Further nodes, such as nodes in a cloud in which the blockchain network is distributed, can thus handle the blockchain with or more intermediate blocks in a regular manner and take into account, for example, only the reference to the preceding transaction block of the respective intermediate block.

The intactness of a blockchain is possible without blocks generated between the first and second intermediate blocks on account of the referencing of the first intermediate block in the second intermediate block.

In accordance with one embodiment, the first intermediate block is a genesis block. In this embodiment, the first intermediate block assumes a special role and is itself the genesis block. The second intermediate block then references the genesis block in addition to the predecessor block. In a embodiment in which the first intermediate block is the genesis block, the blocks can thus be validated starting from the second intermediate block based on the referencing of the genesis block. Transactions stored in blocks between the genesis block and the second intermediate block are not required for tracing the intactness of the blocks starting from the second intermediate block.

In accordance with another embodiment, a genesis block is provided and the first intermediate block is furthermore generated, where the first intermediate block references a block preceding it and also references at least the genesis block. Advantageously, depending on the constitution of the chain or the frequency of the generated blocks, in particular of the generated transaction blocks, independently of the genesis block, the first intermediate block can serve as the reference and dataset for the checksum or hash value formation of the second intermediate block.

In accordance with another embodiment, at least one transaction block is generated between the first intermediate block and the second intermediate block. The second intermediate block is advantageously generated in accordance with a specification that takes account of the conditions of a blockchain application or the constitution of a blockchain and that would accordingly like to obtain intermediate blocks after a certain number of transaction blocks. Here, the specification can provide a wide variety of mechanisms for achieving this goal. The greater the number of transaction blocks provided between the intermediate blocks, then the greater the number of blocks that can be disregarded during checking of the blockchain on the basis of the intermediate blocks and the referencing thereof to preceding intermediate blocks.

In accordance with a further embodiment, for shortening the blockchain at least the number of transaction blocks between the second intermediate block and the first intermediate block is reduced. In particular all transaction blocks generated between the second intermediate block and the first intermediate block are removed.

One or more transaction blocks situated between the first intermediate block and the second intermediate block are removed, and so the size and thus the required storage capacity of the blockchain at a node are reduced.

The node that performs the shortening can be any desired node from among the nodes participating in the blockchain network. Advantageously, the entire blockchain including all transaction blocks should be stored at at least one of the participating nodes in order to be able if necessary to have recourse to the transaction blocks no longer present in the shortened blockchain.

The shortened blockchain can still be checked for intactness or authenticity by using the referencing of the second intermediate block to the first intermediate block. In this way, it is possible to check the intactness of the blocks from a genesis block through to the second intermediate block because the chain, as a result of the referencing to the first intermediate block, is not interrupted even by absent transaction blocks between the first intermediate block and the second intermediate block. Advantageously, both the authenticity of the transactions still available in the shortened blockchain before the first intermediate block, and the authenticity of the transactions after the second intermediate block can be traced, in particular by performing checksum formation via all blocks including the intermediate blocks. The second intermediate block also has the checksums of the first intermediate block. As a result, continuous tracing of the blockchain via checksums is possible even across the gap of the removed transaction blocks. Consequently, the transactions of the non-removed transaction blocks are still also recorded in a manner protected against manipulation in the shortened blockchain.

The fact that the second intermediate block and all further blocks can be trusted is ensured by virtue of the intermediate blocks also being confirmed by the consensus mechanism of the blockchain as in a regular blockchain network.

The shortening of the blockchain is particularly expedient for nodes provided on devices having limited storage capacity. In the industrial sphere these are “edge devices”, for example, which serve as an interface to a cloud and at the same, locally in an industrial installation, can keep available or process data relevant to the installation.

In particular, all transaction blocks between two intermediate blocks are removed. Transactions between two intermediate blocks can be checked without gaps if all are present and accordingly all checksums can be recalculated, as is the case in a conventional blockchain. Shortening of the blockchain can therefore be optimized advantageously with respect to required storage space by virtue of the shortened blockchain containing no transaction block between the second intermediate block and the first intermediate block. In particular cases in which no transaction block was generated between two intermediate blocks, for example, on account of the policy according to which an intermediate block is generated or on account of an absence of generated transaction blocks, the shortening can be effected analogously. Here, an intermediate block contains the checksum over the preceding intermediate block twice, for example, once on account of the referencing of the direct predecessor block and once on account of the referencing of the preceding intermediate block. The shortening of the blockchain does not achieve a reduction of storage space in this special case.

In accordance with another embodiment, a shortened blockchain is stored by a device participating in a distributed database system, in particular a device in a cloud or an edge device or IoT device. In this way, a device having limited storage capacity can flexibly store a shortened blockchain, which takes up less storage space. By way of example, a device firstly stores the unshortened blockchain and then shortens the latter by erasing transaction blocks between arbitrary intermediate blocks.

In accordance with a further embodiment, for extending the blockchain, transaction blocks between the first intermediate block and the second intermediate block are interrogated from a stored unshortened blockchain and are inserted. Advantageously, a shortened blockchain can thus be extended again to an unshortened blockchain. This extension can be performed for transaction blocks between selected intermediate blocks or for all removed transaction blocks, i.e., for transaction blocks between all intermediate blocks between which shortening was previously effected.

In accordance with another embodiment, referencing of a block to be referenced comprises recording or storing a checksum of the block to be referenced or of a part of the block to be referenced in the referencing block. The checksum is, in particular, a hash value or a cryptographic hash value.

In accordance with another embodiment, intermediate blocks each include no transaction. An intermediate block is confirmed by the blockchain network analogously to the conventional method for generating a transaction block, such as mining. Only the content of the generated intermediate block includes no payload data in this configuration. In the case of a shortened blockchain, particularly few transaction data then remain in the shortened blockchain. In accordance with a further embodiment, a block that itself includes a transaction can be designated as an intermediate block. Therefore, an intermediate block can take on a double function and firstly be a transaction block within a blockchain and at the same time, by way of an additional reference to an earlier intermediate block, take on the functionality of an intermediate block. The transaction of an intermediate block is also protected against manipulation because transaction blocks following an intermediate block also reference the intermediate block themselves and thus interlink a transaction recorded there. Transactions stored in intermediate blocks are not removed, however, during shortening of the blockchain.

Removing transaction blocks between all intermediate blocks present, for example, between the genesis block and the first intermediate block and between the first intermediate block and the second intermediate block and between the second intermediate block and a further intermediate block, etc., has the effect that only transactions succeeding the last generated intermediate block are present in a shortened blockchain. This is particularly advantageous in applications in which the history of transaction data that were interlinked before the intermediate block generated last is no longer of interest. In such a scenario, a particularly large amount of storage space can be released or the blockchain requires particularly little storage space and all transaction data of the recent past are nevertheless available. The period of time for which a transaction history is available can advantageously be controlled via the specification for generating the intermediate blocks or, in an alternative, by way of the predefinition of the transaction blocks to be erased.

In accordance with another embodiment, further intermediate blocks are generated, where a respective further intermediate block references a respectively preceding block and also a respectively preceding intermediate block. The method can be extended to as many intermediate blocks as desired, where successive intermediate blocks are each configured analogously to the first and second intermediate blocks. A third intermediate block can thus follow the second intermediate block, a fourth intermediate block can follow the third intermediate block, and on.

In accordance with a further embodiment, generating the second intermediate block or a respective further intermediate block is effected in a rule-based manner, for example, at a predefinable point in time or with a predefinable time gap with respect to a preceding block or a predefinable time gap with respect to a preceding intermediate block or after a predefinable number of generated transaction blocks or via a context-based triggering condition, or is effected manually. It is advantageously possible to define the frequency or the regularity of generated intermediate blocks via a rule for generating intermediate blocks. Depending on the application, intermediate blocks can thus be generated such that transaction blocks can be flexibly removed from specific time ranges.

By way of example, the generated blocks can thus be removed from a selectable time period in a particularly finely granular manner, for example, if the history of the transactions for this time segment is of little interest. By way of example, the intermediate blocks can be created at longer intervals, for applications for which experience shows that only the most up to date transaction data are of interest afterward on a device within the automation installation. By removing transaction blocks from such a range, at once a large amount of storage space can be saved by one action for erasure between two intermediate blocks.

In other applications, an intermediate block can be generated at shorter intervals, for example, if experience shows that only specific parts of the generated transaction blocks are of interest for a historical analysis and other parts can be erased from the history.

Advantageously, an intermediate block is generated only if a certain number of transaction blocks have been generated. This has the effect that an intermediate block is generated only if removal of the transaction blocks as far as the preceding intermediate block exceeds a certain storage space saving as a limit value. This avoids a situation, for example, in which removal of transaction blocks between two intermediate blocks has only little effect on the size or length of the entire blockchain.

Advantageously, in the case of a context-based condition, an intermediate block is generated depending on a context, for example, a context of an automation project. By way of example, a job system controls the creation of an intermediate block. Advantageously, for example, intermediate blocks can be therefore created at the beginning and after the end of a batch. It is thus possible to select removal of transaction blocks between intermediate blocks or likewise the maintenance of these blocks in the blockchain for a specific batch or a specific job.

Furthermore, for example, an intermediate block can be created if a new parameter setting is used in an automated process, for example, after a tool change in a machine tool or after an adaptation of controllers in a production machine as a reaction to environmental influences.

In accordance with yet another embodiment, at least one of the further intermediate blocks references at least two of the preceding intermediate blocks by virtue of a plurality of preceding intermediate blocks being referenced in an intermediate block, for example, by virtue of the hash value of a plurality of preceding intermediate blocks containing the status of the blockchain at the respective point in time. It thus becomes possible to shorten the blockchain to a plurality of lengths proceeding from the doubly referencing intermediate node. That is, for example, the section of the chain between the doubly referencing intermediate node and the older referenced intermediate node or between the doubly referencing intermediate node and the younger referenced intermediate node can be erased from the blockchain.

In one embodiment, an intermediate block can reference all preceding intermediate blocks, for example. Although, on the one hand, the complexity increases on account of the inflation of references in the intermediate block, in this way in one process a very large number of blocks, i.e., of transaction blocks and previous intermediate blocks, can be removed from the blockchain and the blockchain can thus be shortened efficiently.

In accordance with another embodiment, a respective intermediate block references the respectively preceding intermediate block, and selected intermediate blocks additionally reference further preceding intermediate blocks. A compromise can be made in this way so that, on the one hand, the amount of references does not increase in an inflationary manner with newly generated intermediate blocks and selected intermediate blocks nevertheless reference two or more preceding intermediate blocks.

In accordance with a still further embodiment, as a selected intermediate block an intermediate block is generated at a predefinable point in time or with a predefinable time gap with respect to a preceding or previously selected intermediate block or after a predefinable number of generated transaction blocks or intermediate blocks or via a context-based triggering condition, or manually. The mechanisms that trigger the generation of a selected intermediate block with double or multiple referencing can be chosen analogously to the creation of an intermediate block.

It is also an object of the invention to provide a storage medium of a device participating in a distributed database system, in particular of a device in a cloud or of an edge device or IoT device, having a blockchain with blocks comprising an adaptable number of transaction blocks and a plurality of intermediate blocks, where the blockchain forms part of the distributed database system, a respective block references a respective preceding block, the storage medium also has a first intermediate block and at least one second intermediate block, and where the second intermediate block references a block preceding it and also references at least the first intermediate block.

In accordance with one embodiment, the storage medium is implemented on an edge device or an IoT device and has stored a blockchain shortened in accordance with the above-described embodiments of the method.

Advantageously, a blockchain with the intermediate blocks described is generated, distributed, confirmed, managed in a decentralized manner or stored in the blockchain network. A node of the blockchain network can thus decide as desired whether it stores a complete blockchain including the generated transaction blocks and intermediate blocks, or whether it shortens the blockchain in accordance with the above-described embodiments of the method and stores the shortened blockchain. Particularly, nodes of the network which have a limited storage capacity available, such as edge devices or IoT devices within automation installations, can store the shortened blockchain in an advantageous manner.

In accordance with another embodiment, the storage medium is implemented on an edge device or an IoT device and has stored a blockchain extended in accordance the above-described embodiments of the method. Advantageously, at least one node that reliably stores the entire blockchain is provided in the blockchain network. In an automation installation connected to a cloud, this can be a blockchain node of the installation operator or a blockchain node of the cloud service for which an installation operator defines rules, and which stores the entire blockchain including all transaction blocks. From this, for example, a device of the automation installation that has stored only a shortened blockchain can then request the transaction blocks not contained in the shortened blockchain and incorporate them into the blockchain again. In particular, this process can involve checking whether all transaction blocks requested and provided are present in an intact and unmanipulated form, by tracing the checksums of the blocks. In this way, the device that has stored a shortened blockchain acquires the extended blockchain again after the incorporation of the blocks from the complete blockchain. Here, all removed blocks can be requested, or only portions, such that the blockchain is present on the edge device or IoT device in an extended form, although still in a reduced form vis-à-vis the complete blockchain.

It is also an object of the invention to provide an edge device having a storage medium in accordance with one of the above-described embodiments of the storage medium.

It is a further object of the invention to provide a computer program product with a computer program which has means for implementing the method in accordance with any of the above-described embodiment when the computer program is executed on a program-controlled device that includes a processor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below using examples with the aid of the figures, in which:

FIG. 1 shows a schematic illustration of two blockchains in accordance with a first exemplary embodiment of the invention;

FIG. 2 shows a schematic illustration of two blockchains in accordance with a second exemplary embodiment of the invention;

FIG. 3 shows a schematic illustration of two blockchains in accordance with a third exemplary embodiment of the invention;

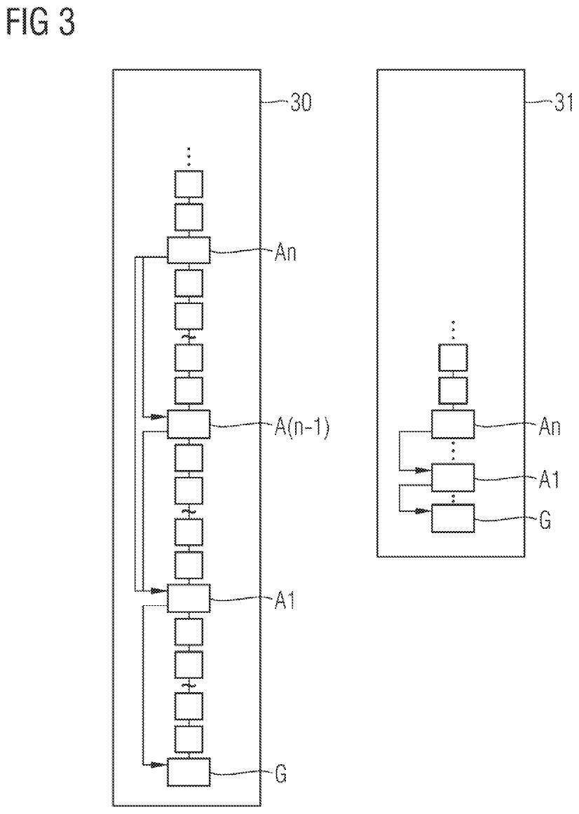

FIG. 4 shows a schematic illustration of two blockchains in accordance with a fourth exemplary embodiment of the invention;

FIG. 5 shows a schematic illustration of blockchain network nodes within a cloud environment and blockchain network nodes in an automation installation; and

FIG. 6 is a flowchart of the method in accordance with the invention.

### DETAILED DESCRIPTION OF THE EXEMPLARY EMBODIMENTS

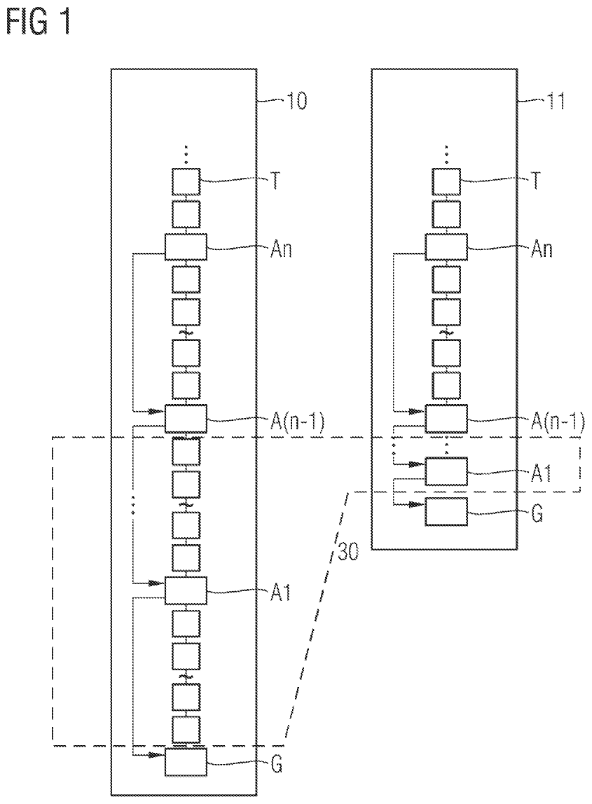

In accordance with a first exemplary embodiment of the invention, a blockchain is generated n such that, besides regular transaction blocks, intermediate blocks are generated at regular intervals. Here, the blockchain is based on a genesis block G. Transaction blocks are created based on the genesis block G and interlinked into the blockchain. A transaction block T of this type is identified by way of example in FIG. 1. For the sake of simplicity, only one transaction block has been provided with a reference sign for elucidation purposes. Following a predefinable and flexibly selectable time gap with respect to the genesis block G, a first intermediate block A1 is created. The created first intermediate block A1 itself includes no transaction, but is created in a similar manner to a transaction block, sent as a broadcast to the blockchain network, confirmed by a consensus mechanism used in the blockchain, and interlinked into the blockchain. Here, the first intermediate block A1 references as usual directly the preceding transaction block and additionally the genesis block G.

If the first intermediate block A1 is successfully confirmed by participating nodes at the distributed database system that uses the blockchain, in particular by “mining”, then the first intermediate block A1 continues the blockchain like a regular block.

Further intermediate blocks are generated with a certain time gap with respect to the first intermediate block A1. The (n−1)-th intermediate block Aₙ₋₁ is also generated in this sequence. The n-th intermediate block A_{N} is generated in turn with a time gap with respect thereto. In accordance with the first exemplary embodiment of the invention, the blockchain 10 thus generated is distributed within a blockchain network, for example, within a private blockchain network. By way of example, a blockchain network is provided within a gathering of businesses that are collaborating for production of a product at various operational stages. Here, the complete blockchain 10 is stored, for example, in a respective node of the companies involved.

Nodes of individual companies that are situated within an automation network are likewise part of the blockchain network. The automation network is connected to the blockchain network NW. By way of example, one of the nodes of the blockchain network is provided on an IoT device. The available storage space on the IoT device is limited. By way of example, the IoT device performs control tasks within the installation and is simultaneously connected to an office or IT network. The IoT device is addressable via the internet, in particular. The IoT device accesses the blockchain in order to have available, for example, transactions for a current automation project or for a current batch in a manner protected against manipulation. These transaction data can consist of parameter sets or configuration parameters, for example.

The transaction data can likewise comprise order data of a job. By way of example, a region of the blockchain that contains transaction data that were created after the (n−1)-th intermediate block Aₙ₋₁ is of interest for the IoT device.

The IoT device can advantageously store a shortened blockchain 11. For this purpose, transaction blocks that were created temporally before the (n−1)-th intermediate block are removed from the blockchain. The intermediate blocks are maintained in the blockchain in the process. This gives rise to a chain comprising the genesis block G, the first intermediate block A₁, optionally further intermediate blocks, the (n−1)-th intermediate block Aₙ₋₁ and transaction blocks following the intermediate block Aₙ₋₁. A blockchain 11 shortened in this way and the current transaction blocks contained therein can be validated proceeding from the genesis block G by virtue of the possibility of tracing the checksum formation by way of the individual blocks. On account of the inclusion of the checksums from a respective preceding intermediate block in an intermediate block, the chain of blocks such as those contained in the shortened blockchain 11 can be validated.

The required storage space for the shortened blockchain 11 has been reduced by the size of all the removed transaction blocks. Both the generation of the (n−1)-th intermediate block Aₙ₋₁ and the selection thereof as intermediate block for erasing preceding transaction blocks can be effected in a manner adapted to the automation project. If the generation of the intermediate blocks depends on a selectable time gap with respect to previous intermediate blocks, then an intermediate block that was generated before the section of interest in the blockchain can accordingly be selected during the shortening of the blockchain.

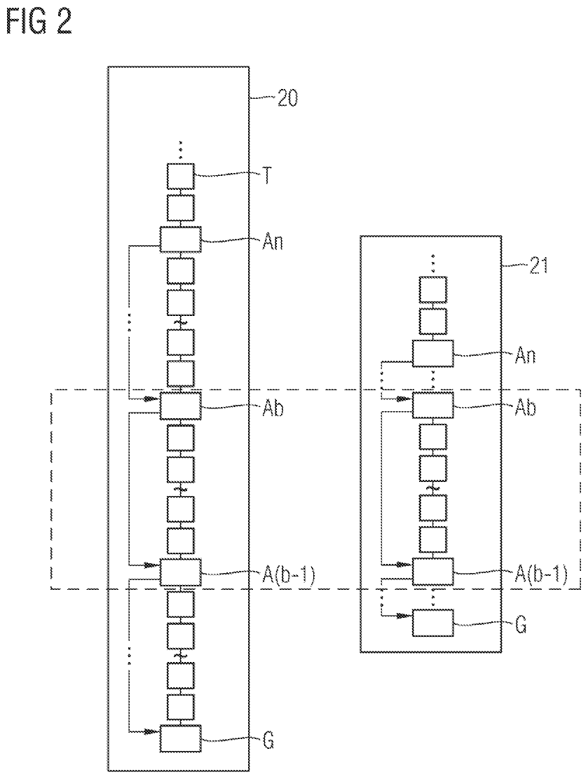

FIG. 2 illustrates a second exemplary embodiment of the invention, in which a blockchain 20 is created in a manner similar to the blockchain 10 described in the context of FIG. 1. In contrast to the first exemplary embodiment, for shortening the blockchain 20 by removing transaction blocks before the intermediate block Aₙ, a section of the blockchain is excluded from the removal of the intermediate blocks. Transaction blocks lying between the (b−1)-th intermediate block A_{b-1} and the b-th intermediate block A_{b} are not removed in accordance with the second exemplary embodiment of the invention. A shortened blockchain 21 is thus created that removes older transaction blocks that were generated before the intermediate block Aₙ, apart from those between the (b−1)-th intermediate block A_{b-1} and the b-th intermediate block A_{b}.

Consequently, the blockchain 20 is effectively reduced to a shortened blockchain 21 and the storage space that becomes free as a result of the removed transaction blocks is saved in the process. However, a time range is deliberately excluded, such that transaction blocks from this time range are also available in the shortened blockchain 21. By way of example, in the shortened blockchain 21, “golden batches”, which are known from process engineering and represent a yardstick for current production batches, are thus maintained as retrievable transaction data in the blockchain in order to also be able to perform a corresponding comparison of the batch data in the shortened blockchain. In addition, for example, the most recent transaction data that were generated after the intermediate block Aₙ are maintained as history.

In accordance with a third exemplary embodiment of the invention, a blockchain 30 is created such that, for example, the n-th intermediate block Aₙ additionally references the first intermediate block A₁, for example, besides the directly preceding transaction block and the (n−1)-th intermediate block Aₙ₋₁ generated last. In one embodiment, the n-th intermediate block Aₙ references even further intermediate blocks (not depicted). During shortening of the blockchain 30 to a shortened blockchain 31, it is thus possible to remove, between a selected time range, such as between the first intermediate block A1 and the n-th intermediate block Aₙ besides the transaction blocks from this period of time also the generated intermediate blocks in this period of time, in particular the (n−1)-th intermediate block Aₙ₋₁.

The complete checkability of the blockchain chain is nevertheless ensured in the shortened blockchain 31 by the reference of the n-th intermediate block Aₙ to the first intermediate block A₁. It is advantageously provided that not all intermediate blocks reference a plurality of preceding intermediate blocks, in order to avoid inflation of references and complexity associated therewith. At longer time intervals, however, it is possible to provide such an intermediate block particularly containing an additional intermediate block as checksum.

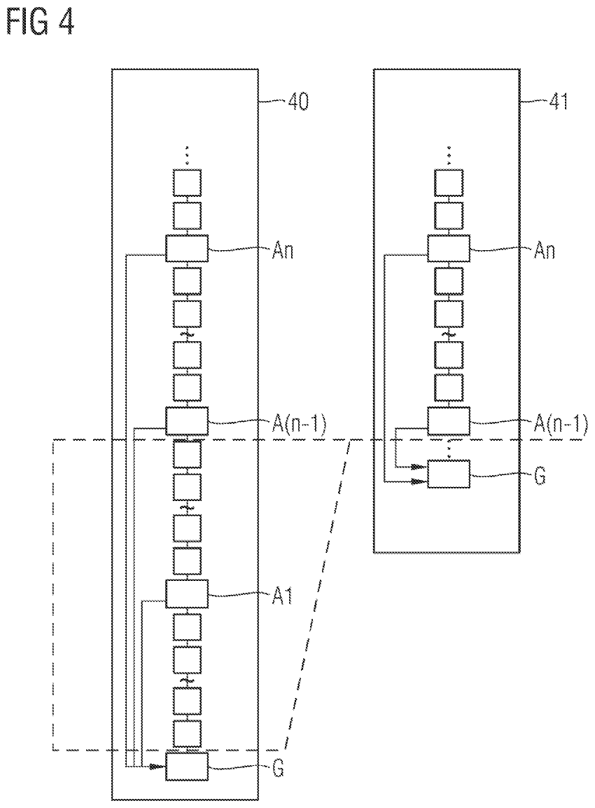

FIG. 4 shows a further possible alternative for creating a blockchain 40 with intermediate blocks. Here, a plurality or in particular all of the generated intermediate blocks also reference the genesis block G. A shortened blockchain 41 can then be generated such that transaction data before an (n−1)-th intermediate block Aₙ₋₁ are removed. The blockchain is thus automatically shortened to the shortest possible length. This configuration may be of interest for applications in which transaction data in an initial phase of the blockchain are irrelevant, for example, because they are test data or test configuration data sets to which recourse is not intended to be had in the rest of the procedure, for example, because they lead to poor or non-optimized installation conditions.

The possibilities for referencing intermediate blocks and corresponding possibilities for shortening the blockchain, as described in exemplary embodiments 1 to 4, can also be used in combination. By way of example, it is possible to use different mechanisms for generating the intermediate blocks at different time segments of the blockchain. Likewise, the trigger mechanism for creating an intermediate block can vary within a blockchain. By way of example, at the beginning of a blockchain that is reestablished when an automation installation is started up, a fixed time gap can be predefined, while in contrast intermediate blocks are triggered in a context-based manner in the further course of events.

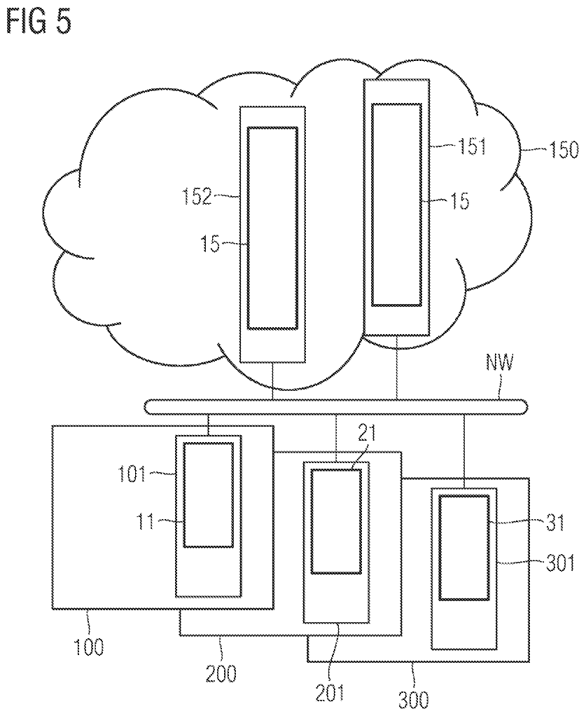

Reference is made to FIG. 5 to elucidate how shortened blockchains 11, 21, 31 are used in an application scenario of an automation installation. FIG. 5 shows a blockchain network NW consisting of blockchain nodes 151, 152, 101, 201, 301. Only five nodes participating in the blockchain network NW have been depicted, for illustration reasons. A multiplicity of nodes participate particularly in a cloud 150, illustrated in the upper half of the depiction in FIG. 5. The nodes 151, 152 in the cloud 150 are connected to nodes within an automation installation 101, 201, 301 via the blockchain network NW.

The nodes of the automation installations are depicted in the lower half of FIG. 5. This can involve an industrial installation, for example, in which the nodes 101, 201, 301 are located spatially close together and are formed on different devices 100, 200, 300 of the automation installation. The nodes can likewise be provided in a plurality of spatially separated installations belonging to a business, for example.

Furthermore, the nodes illustrated in FIG. 5 could be provided in networks of different businesses.

With reference to FIG. 5, the intention is to elucidate the fact that enough storage space is generally available for nodes in the cloud 150. By contrast, available storage is often a limiting factor in nodes of devices 100, 200, 300 within automation installations.

By way of example, in a first automation installation, an edge device 100 is provided, which serves as a gateway between an automation network, which regulates the control of automation devices, and a communication network in the cloud 150. In this case, the edge device 100 collects data of the automation system that can be used for a service in the cloud 150. By way of example, monitoring data that are intended to be made available for a big data analysis in the cloud 150 are collected in this way. By way of example, the edge device 100 preprocesses the collected data before it sends them into the cloud. In this case, by way of example, the recorded data are anonymized or data are collected from specific time segments or made available in a manner sorted according to time segments.

In another automation installation, an edge device 200 is provided, for example, which is additionally responsible for encrypted exchange with the cloud service.

In a further automation installation, an IoT device 300 is provided, for example, which for example controls a packaging process and simultaneously has a communication connection to a logistics provider via an internet connection.

What the edge device 100, the edge device 200 and the IoT device 300 have in common here is that the available storage space is limited. The devices thus have an interest in saving storage space. In addition, in accordance with the fifth exemplary embodiment of the invention, a blockchain application is implemented on the devices. Here in each case, data concerning operating actions or quality experts are intended to be safeguarded by way of a blockchain. These data are intended to be present in demonstrably unmanipulated form in the blockchain.

At the same time the devices described, the edge device 100, the edge device 200 and the IoT device 300, are used to a degree close to automation during the production and processing of a product. That is, generally a rather more recent history of acquired data is relevant locally. Data from this short-term archive should therefore advantageously be available on the respective device. At the same time, however, the blockchain is also intended to take up as little storage space as possible on the respective device. This challenge is solved by the respective node 101, 201, 301 on the respective device 100, 200, 300 respectively storing a shortened blockchain 11, 21, 31. The above-described blockchains are suitable as shortened blockchain 11, 21, 31.

There are a number of possibilities as to how a respective node 101, 201, 301 attains a shortened blockchain. By way of example, as long as enough storage is available, the blockchain can be maintained regularly and without being shortened. As soon as a certain proportion of storage space is occupied by the blockchain, a mechanism is triggered for shortening the blockchain. In this method, a respective node on the respective automation device has available the maximum number of transaction blocks and thus also of performed transactions, such as recorded quality data, until the available storage space is no longer sufficient. Starting from this point in time, a part of the blockchain can be regularly erased, for example, or a larger section of the blockchain can be erased once, for example, until the threshold value for storage space occupancy is exceeded again.

In another embodiment, a node 101 from an automation installation regularly interrogates a status of a blockchain from the network, for example, by the node communicating with a node 152 in the cloud, and at the same time it removes the irrelevant transaction blocks in the process. In this way, a shortened blockchain is stored on the edge device 100 as it were from the outset.

This advantageously prevents a blockchain on a node that performs shortening of the blockchain from continuously increasing and thus causing an overflow of the storage.

Particularly in the case of intermediate blocks that themselves include no transactions, but rather only the reference to the last block and also the predecessor intermediate block, the footprint of an intermediate block is constantly small. The increase in concatenated intermediate blocks no longer poses a risk even for devices with limited resources.

Blocks are advantageously erased locally at a blockchain node. In particular, therefore, as many devices as desired that are located in the blockchain network NW and have their specific limitations with respect to available resources can remove flexibly different time ranges from the locally stored blockchain. The shortened blockchain can also be referred to as a stripped blockchain, and the node having the shortened blockchain as a stripped node.

The disclosed embodiments of the invention makes possible targeted erasure and at the same time deliberate maintenance of relevant payload data stored in a blockchain in a chosen period of time that can be determined via intermediate blocks.

A shortened blockchain or a stripped node can again request already erased blocks from a complete blockchain or a full node and interlink them into the corresponding regions between the intermediate blocks selected for erasure. This is particularly advantageous if data from the removed region of the blockchain become relevant for a later analysis, for example, because a customer of a product that originates from a batch would like to acquire information concerning the supply chain. Furthermore, the data from the removed region may also be required as reference data for a configuration of a control installation.

At the same time, it is also ensured that current transactions are locally available on the shortened blockchains. Apart from the fact that the intermediate blocks are flexibly selectable for the removal and more up to date intermediate blocks therefore need not be selected, the time range that was generated after the intermediate block generated last is excluded from the erasure of the data.

Current transactions are thus immediately available ubiquitously with availability of their block in the blockchain network, i.e., an interrogation of the most up to date production data is possible via the cloud just like the interrogation of the historical data.

Historical information within a blockchain network therefore need only be present in blockchain nodes in which it is actually relevant, such as on long-term archive servers or in a cloud. At the same time, for example an IoT device that operates a reduced or stripped blockchain node is started significantly more rapidly because erased blockchain regions do not have to be loaded.

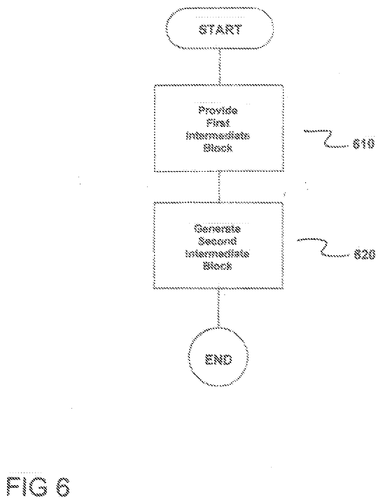

FIG. 6 is a flowchart of the computer-implemented method for creating a blockchain 10, 11, 20, 21, 30, 31, 40, 41 with blocks comprising an adaptable number of transaction blocks T and a plurality of intermediate blocks A1, A(b 1), Ab, A(n 1), An, where the blockchain 10, 11, 20, 21, 30, 31, 40, 41 forms part of a distributed database system NW, blocks are generated within the blockchain 10, 11, 20, 21, 30, 31, 40, 41 and a respective block references a respective preceding block within the block chain.

The method comprises providing a first intermediate block A1, G, as indicated in step 610.

Next, at least one second intermediate block A2 that references a block that precedes the at least one second intermediate block A2 and references at least the first intermediate block A1, G is generated, as indicated in step 620. In accordance with invention, the first intermediate block A1, G comprises a predecessor intermediate block.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-19. (canceled)

20. A computer-implemented method for creating a blockchain with blocks comprising an adaptable number of transaction blocks and a plurality of intermediate blocks, the blockchain forming part of a distributed database system, blocks being generated within the blockchain and a respective block referencing a respective preceding block within the block chain, the method comprising:
providing a first intermediate block; and
generating at least one second intermediate block which references a block which precedes the at least one second intermediate block and references at least the first intermediate block;
wherein the first intermediate block comprises a predecessor intermediate block.

21. The method as claimed in claim 20, wherein the first intermediate block comprises a genesis block.

22. The method as claimed in claim 20, wherein the genesis block is provided and the first intermediate block is furthermore generated, wherein the first intermediate block references a block preceding the first intermediate block and references at least the genesis block.

23. The method as claimed in claim 20, wherein at least one transaction block is generated between the first intermediate block and the at least one second intermediate block.

24. The method as claimed in claim 20, wherein at least the number of transaction blocks between the at least one second intermediate block and the first intermediate block is reduced to shorten the blockchain.

25. The method as claimed in claim 24, wherein shortening the blockchain comprises removing all transaction blocks generated between the at least one second intermediate block and the first intermediate block.

26. The method as claimed in claim 20, wherein a shortened blockchain is stored by a device participating in a distributed database system.

27. The method as claimed in claim 26, wherein the device comprises one of (i) a device in a cloud, (ii) an edge device and (iii) IoT device.

28. The method as claimed in claim 20, wherein transaction blocks between the first intermediate block and the at least one second intermediate block are interrogated from a stored unshortened blockchain and are inserted into the blockchain to extend the blockchain.

29. The method as claimed in claim 20, wherein referencing of a block to be referenced comprises recording or storing a checksum of the block to be referenced or of a part of the block to be referenced in the referencing block.

30. The method as claimed in claim 20, wherein the first intermediate block and the at least one second intermediate block each include no transaction.

31. The method as claimed in claim 20, wherein further intermediate blocks, are generated; and wherein a respective further intermediate block references a respectively preceding block and a respectively preceding intermediate block.

32. The method as claimed in claim 20, wherein generating one of (i) the at least one second intermediate block and (ii) a respective further intermediate block, is effected one of (i) in a rule-based manner and (ii) manually.

33. The method as claimed in claim 32, wherein the rule-based manner comprises one of (i) at a predefinable point in time, (ii) a predefinable time gap with respect to a preceding block, (iii) a predefinable time gap with respect to a preceding intermediate block (iv) after a predefinable number of generated transaction blocks, (v) via a context-based triggering condition.

34. The method as claimed in claim 31, wherein at least one of the further intermediate blocks references at least two of the preceding intermediate blocks.

35. The method as claimed in claim 32, wherein at least one of the further intermediate blocks references at least two of the preceding intermediate blocks.

36. The method as claimed in claim 20, wherein a respective intermediate block references the respectively preceding intermediate block; and wherein selected intermediate blocks additionally reference further preceding intermediate blocks.

37. The method as claimed in claim 36, wherein as selected intermediate block an intermediate block is generated one of (i) at a predefinable point in time, (ii) with a predefinable time gap with respect to a preceding or previously selected intermediate block, (iii) after a predefinable number of generated transaction blocks or intermediate blocks, (iv) via a context-based triggering condition and (v) manually.

38. A storage medium of a device participating in a distributed database system, the storage medium comprising:
a blockchain having blocks comprising an adaptable number of transaction blocks and a plurality of intermediate blocks, the blockchain forming part of the distributed database system and a respective block referencing a respective preceding block; and
a first intermediate block and at least one second intermediate block;
wherein the at least one second intermediate block references a block preceding said at least one second intermediate block and references at least the first intermediate block; and
wherein the first intermediate block is a predecessor intermediate block.

39. The storage medium as claimed in claim 38, wherein the storage medium is implemented on one of (i) an edge device and (ii) an IoT device, said storage device storing a shortened blockchain which is shorted by reducing at least the number of transaction blocks between the at least one second intermediate block and the first intermediate block.

40. The storage medium as claimed in claim 38, wherein the storage medium is implemented on one of (i) an edge device and (ii) an IoT device, the storage medium storing a blockchain which is extended by interrogating transaction blocks between the first intermediate block and the at least one second intermediate block from a stored unshortened blockchain and inserting said interrogated transaction blocks into the blockchain.

41. The storage medium as claimed in claim 38, wherein the device comprises one of (i) a device in a cloud, (ii) an edge device and (iii) or IoT device.

42. An edge device having the storage medium as claimed in claim 38.

43. A non-transitory computer-readable medium encoded with a computer program which, when executed by a processor of program-controlled device, causes creation of a blockchain with blocks comprising an adaptable number of transaction blocks and a plurality of intermediate blocks, the blockchain forming part of a distributed database system, blocks being generated within the blockchain and a respective block referencing a respective preceding block within the block chain, the computer program comprising:
program code for providing a first intermediate block;
program code for generating at least one second intermediate block which references a block which precedes the at least one second intermediate block and references at least the first intermediate block; and
wherein the first intermediate block comprises a predecessor intermediate block.
